(19) United States
(12) Patent Application Publication
(10) Pub. No.: US 2017/0149552 A1
(43) Pub. Date: May 25, 2017

(54) Method for Informing Switching Patterns of Half Duplex Communications in LTE

(71) Applicant: Nokia Solutions and Networks Oy, Espoo (FI)

(72) Inventors: Benny VEJLGAARD, Gistrup (DK); Rapeepat RATASUK, Hoffman Estates, IL (US); Nitin MANGALVEDHE, Hoffman Estates, IL (US); Amitabha GHOSH, Buffalo Grove, IL (US)

(21) Appl. No.: 15/318,766

(22) PCT Filed: Jun. 17, 2014
(86) PCT No.: PCT/EP2014/062664

§ 371 Date: Dec. 14, 2016

(51) Int. Cl. H04L 5/16; H04W 56/00; H04W 72/08; H04L 5/00; H04W 72/04

(52) U.S. Cl. CPC H04L 5/16; H04L 5/0094; H04W 72/0406; H04W 72/0446; H04W 72/085; H04W 56/001; H04L 5/0048

(57) ABSTRACT

A method is provided for transmission control of a user terminal utilizing half-duplex frequency division duplex operation. The method includes defining a transmission qap pattern for at least one user terminal. The transmission gap pattern indicates 1) sub-frames during which the user terminal is to perform uplink transmission, 2) sub-frames during which the user terminal is to expect to perform downlink reception including at least reference symbols for performing downlink tracking, and 3) at least one of a Tx-to-Rx switching sub-frame during which the user terminal is to switch from the uplink transmission to the downlink reception, and a Rx-to-Tx switching sub-frame during which the user terminal is to switch from the downlink reception to the uplink transmission. The transmission qap pattern is provided to the user terminal, and the user terminal is operated according to the transmission qap pattern.

### FIELD OF THE INVENTION

The exemplary and non-limiting embodiments of this invention relate generally to wireless communications networks, and more particularly to enhancing frequency stability of a user terminal.

### BACKGROUND ART

The following description of background art may include insights, discoveries, understandings or disclosures, or associations together with dis-closures not known to the relevant art prior to the present invention but provided by the invention. Some such contributions of the invention may be specifically pointed out below, whereas other such contributions of the invention will be apparent from their context.

The amount of available radio resources for LTE-M is fixed based on LTE frame structure and a LTE-M super-frame principle. A target is to transmit the same information by using fewer resources. This may be achieved e.g. by minimizing the size of control and feedback messages, or by optimizing the resource utilization by traffic aggregation or novel signal formats. An objective is cost and complexity reduction. However, that may cause degradation of the link budget, particularly in an uplink, leading to insufficient coverage of LTE-M devices. Thus, a high level of coverage of machine type communications (MTC) is a challenge in mobile wireless network domains.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise a method, apparatus, and a computer program product as defined in the independent claims. Further embodiments of the invention are disclosed in the dependent claims.

An aspect of the invention relates to a method for transmission control of a user terminal utilizing a half-duplex frequency division duplex operation mode, the method comprising receiving a transmission pattern in the user terminal, the transmission pattern indicating 1) sub-frames during which the user terminal is to perform uplink transmission, 2) sub-frames during which the user terminal is to expect to perform downlink reception including at least reference symbols for performing downlink tracking, and 3) at least one of a Tx-to-Rx switching sub-frame during which the user terminal is to switch from the uplink transmission to the downlink reception, and a Rx-to-Tx switching sub-frame during which the user terminal is to switch from the downlink reception to the uplink transmission; and operating the user terminal according to the transmission pattern.

A further aspect of the invention relates to a method for transmission control of a user terminal utilizing half-duplex frequency division duplex operation, the method comprising defining a transmission pattern for at least one user terminal, the transmission pattern indicating 1) sub-frames during which the user terminal is to perform uplink transmission, 2) sub-frames during which the user terminal is to expect to perform downlink reception including at least reference symbols for performing downlink tracking, and 3) at least one of a Tx-to-Rx switching sub-frame during which the user terminal is to switch from the uplink transmission to the downlink reception, and a Rx-to-Tx switching sub-frame during which the user terminal is to switch from the downlink reception to the uplink transmission; and providing the transmission pattern to the user terminal.

A still further aspect of the invention relates to an apparatus comprising at least one processor, and at least one memory including a computer program code, wherein the at least one memory and the computer program code are configured to, with the at least one processor, cause the apparatus to perform any of the method steps.

A still further aspect of the invention relates to a computer program product comprising executable code that when executed, causes execution of functions of the method.

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of preferred embodiments with reference to the attached drawings, in which

FIG. 1 illustrates a frequency error for a low-cost crystal oscillator as a function of temperature;

FIG. 2 illustrates a time required to transmit an uplink packet;

FIG. 3 illustrates a transmission gap in HD-FDD transmission;

FIG. 4 illustrates a switching time in HD-FDD transmission;

FIG. 5 shows a simplified block diagram illustrating exemplary system architecture;

FIG. 6 shows a simplified block diagram illustrating exemplary apparatuses;

FIG. 7 shows a messaging diagram illustrating an exemplary messaging event according to an embodiment of the invention;

FIG. 8 shows a schematic diagram of a flow chart according to an exemplary embodiment of the invention;

FIG. 9 shows a schematic diagram of a flow chart according to an exemplary embodiment of the invention.

### DETAILED DESCRIPTION OF SOME EMBODIMENTS

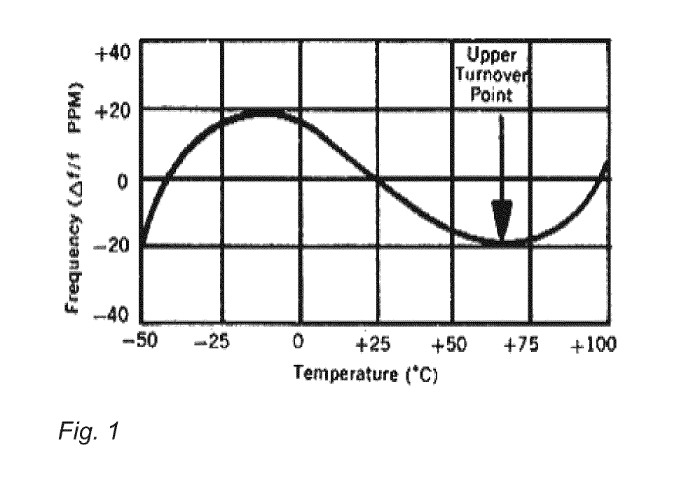

An LTE user terminal may comprise a local oscillator for keeping a timing and frequency reference. The accuracy of the local oscillator may be dependent on the type of the oscillator (e.g. the local oscillator may be an accurate high-cost temperature compensated crystal oscillator (TCXO), or a less accurate low-cost crystal oscillator (XO) without in-built compensation). Low-cost LTE-M devices use a crystal oscillator (XO) for obtaining a clock reference. The crystal oscillator (XO) typically has an accuracy of about 20 ppm, with a closed loop correction of the frequency. FIG. 1 illustrates a frequency error for the low-cost crystal oscillator as a function of temperature, wherein the clock reference drifts further beyond 20 ppm when the temperature changes. Therefore, for the low-cost crystal oscillator, the clock is to be updated regularly based on reference symbols in order to correct the frequency error.

An LTE system operates in a full-duplex (FD) operation mode, meaning that both uplink and downlink are available at the same time. The LTE system utilizes the full-duplex operation mode to transmit downlink reference symbols (i.e. pilots) to be used in the user terminal to correct the frequency error of the local oscillator.

Other systems such as GSM that operate in a half-duplex (HD) operation mode may use the same methodology for transmitting reference symbols in the downlink, wherein symbols are slightly delayed as uplink and downlink transmissions are interleaved. This still works reliably as the delay between the uplink and downlink transmission is typically equal to a GSM frame length and in the worst every-silent-frame case 480 ms for discontinuous transmission (DTX). However, for the worst every-silent-frame case a continuous frequency reference is transmitted in a frequency correction burst (FCB) and synchronization burst (SCB).

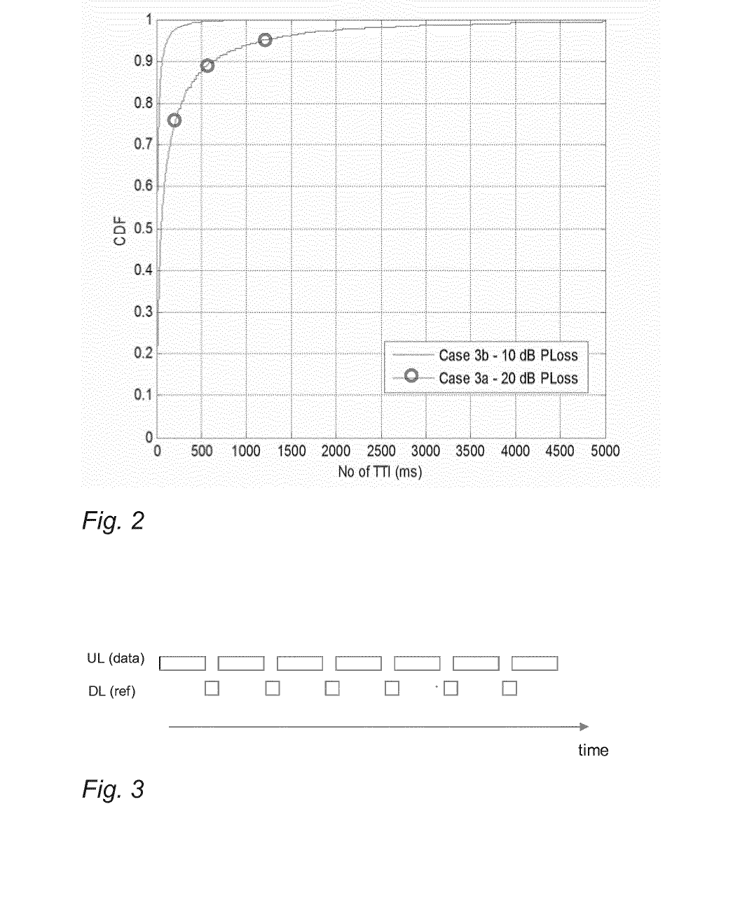

FIG. 2 illustrates the time required to transmit a 100-byte packet in the uplink. For the 99th percentile it typically takes up to 4 seconds to transmit a 100-byte uplink packet, as illustrated in FIG. 2.

When transmitting with extended coverage (corresponding to providing up to a 20 dB additional coverage compared to a reference system), the transmission is carried out for about 4 seconds in the uplink, wherein the UE oscillator system heats up creating a significant frequency drift, and the downlink reference symbols may be missing for long durations (e.g. up to 4 seconds).

In the situation of FIG. 1, there is a temperature drift of 20 ppm which corresponds to a 40 kHz frequency drift (at 2 GHz). If operating with a temperature drift within 0.1 ppm is a requirement, an update at least every 5 ms is required in order to keep the clock within the requirement.

To cope with the frequency drift in the half-duplex system with long uplink periods, a temperature compensated crystal oscillator may be used in the device. The temperature compensation oscillator automatically follows the temperature drift and automatically compensates for the temperature drift. However, the temperature compensated crystal oscillators (TCXO) involve a high cost. The high cost of the temperature compensated crystal oscillators (TCXO) leads to a higher cost of the devices.

In an exemplary embodiment, for HD-FDD, a transmission gap is created in the uplink transmission for the user terminal (UE) to perform a downlink measurement in order to maintain clock stability. In LTE-FDD, the reference symbols are available in every sub-frame, so there are available reference symbols for regular frequency tracking and updating, as illustrated in FIG. 3.

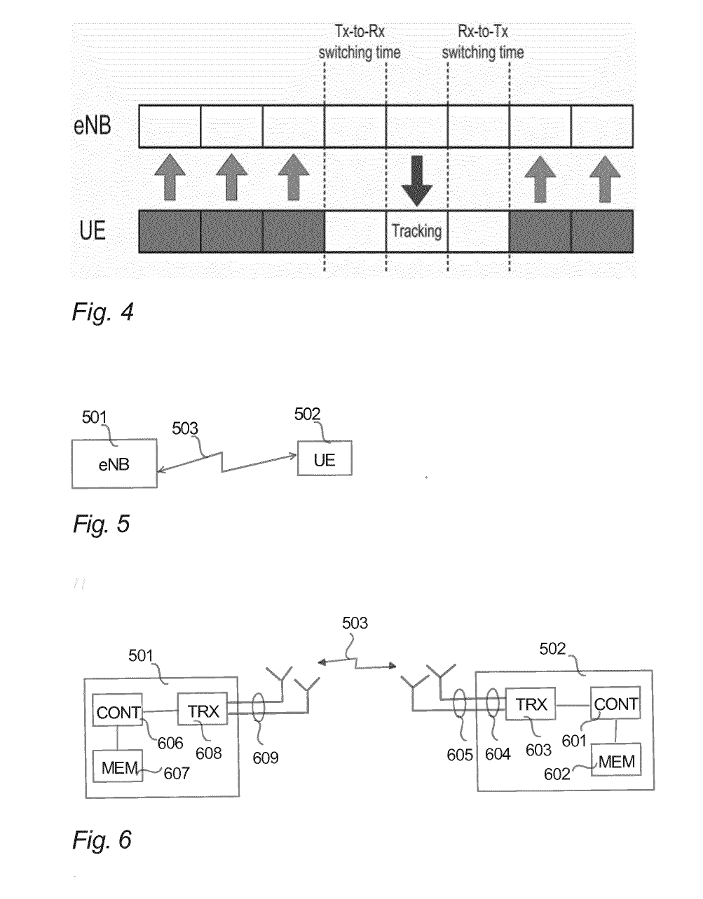

The length of the transmission gap depends on the accuracy of the crystal oscillator (XO). For example, there may be reference symbols during 1 ms of downlink transmission for every 5 ms, leaving up to 4 ms for uplink data. The transmission gap accounts for a transition between uplink (UL) and downlink (DL) in a HD-FDD user terminal. If only a single crystal oscillator XO is used, in order to save costs, RAN4 defines a Tx-to-Rx switching time to be 1 ms, and Rx-to-Tx switching time to be 1 ms, as illustrated in FIG. 4.

If two crystal oscillators (XO) are used, then it is defined that a guard period is created by the user terminal by not receiving the last part of a downlink sub-frame immediately preceding an uplink sub-frame from the same user terminal. Both Rx-to-Tx and Tx-to-Rx switching times are included in this guard period, wherein the Tx-to-Rx switching time is handled by means of a timing advance in the same way as for a time division duplex (TDD) operation mode.

The transmission gap for downlink reference symbols may be created by using a suitable implementation (e.g. by not allowing a base station (eNB) to schedule the user terminal for more than 4 or 5 ms consecutively). However, this is inefficient for long transmissions as in that case the base station (eNB) needs to schedule the user terminal (UE) several times. This wastes control channel PDCCH resources (i.e. produces a high control channel overhead), and also results to a high data channel overhead due to packet segmentation.

In an exemplary embodiment, one or more transmission patterns are defined for a HD-FDD user terminal in a coverage extension mode and/or in a coverage enhancement mode. In an exemplary embodiment, the transmission patterns may be defined to be similar to DL-UL configurations in the time division duplex (TDD) operation mode.

The HD-FDD DL-UL configurations may be defined to be similar to the DL-UL configurations in the time division duplex (TDD) operation mode. For example, the configurations may be as follows:

Config0—UUUSDSUUUU,

Config1—UUUSDDDSUU,

Config2—UDSUUUUUUU,

Config3—USDSUUSDSU,

where U=uplink sub-frame, D=downlink sub-frame, S=switching subframe. For HD-FDD UE with 2 local oscillators, only one switching sub-frame is required. In case of a new carrier type (NCT), “D” lines up with PSS and SSS (in FDD, both PSS and SSS are transmitted in the same sub-frame), and for a legacy system “D” may line up with any sub-frame. In the switching sub-frame (S), some information similar to DwPTS may be sent.

Transmission patterns comprising orthogonal or non-concurrent uplink sub-frames may be supported in order to avoid or minimize the number of idle uplink sub-frames. Different user terminals may thus be configured with transmission patterns including non-concurrent uplink sub-frames. For example, the transmission patterns may be as follows:

UE1 may be configured with a pattern: UUUSDSUUUU,

UE2 may be configured with a pattern: DDDSUSDDDD.

In another example,

UE1 may be configured with a pattern: UUUSDSUUUU,

UE2 may be configured with a pattern: DDSUUUSDDD.

The HD-FDD user terminal is configured with a transmission pattern by a network as part of a connection set-up procedure. With any configured transmission pattern, the user terminal knows when to expect the downlink sub-frame with the reference symbols required for tracking. Thus, an exemplary embodiment discloses providing alternative reference symbols to the user terminal.

The configured pattern may be based on a user terminal capability (e.g. number of local oscillators, switching time, cell size etc.), required amount of coverage extension (i.e. how long the user terminal is expected to transmit in the uplink), eNB receiver performance (e.g. how well the base station is able to track and compensate for the frequency error at the user terminal, i.e. the required frequency of the downlink reference symbols), and/or UL/DL traffic distribution.

The base station may adaptively change the transmission pattern for the HD-FDD user terminal based on performance metrics.

Herein, an orthogonal transmission pattern refers to a transmission pattern that is orthogonal to some other transmission pattern(s) (possibly assigned for some other user terminal(s)). An orthogonal transmission pattern may also be referred to as a non-concurrent transmission pattern.

The base station may schedule the user terminal to transmit for an extended period of time by using only one scheduling assignment or semi-persistent scheduling assignment. Thus, the user terminal may be scheduled to perform uplink transmissions in multiple sub-frames with a single scheduling assignment or a semi-persistent scheduling assignment. Based on the transmission pattern, both the base station and the user terminal know when the user terminal switches to the downlink sub-frame for tracking. For example, the base station may schedule the user terminal to transmit 1 packet repeated over 500 TTIs (500 ms). The user terminal applies the configured pattern and only transmits on sub-frames marked as “U”.

It may also be possible for the base station to transmit information to the user terminal for early termination during the gap period (i.e. during the downlink sub-frames transmitted to the user terminal). For example, the base station may schedule the user terminal to transmit 1 packet repeated over 500 transmission time intervals TTI (500 ms). After 300 transmission time intervals TTI, the base station is able to decode the packet. The base station may then send an acknowledgement (ACK) message to the user terminal during a downlink measurement gap in order to command the user terminal to stop the uplink transmission.

For low-cost LTE-M communication, an exemplary embodiment enables enhancing the coverage of LTE by 20 dB. The coverage enhancement is obtainable primarily by repetition, retransmission, and/or PSD boosting etc. of a transmitted signal. Furthermore, the system operates in the half-duplex operation mode of a frequency division duplex (FDD) system to enable lower cost devices (as a duplex filter is no longer required).

An exemplary embodiment enables enhancing frequency stability of the low-cost crystal oscillators in the LTE-M system. An exemplary embodiment enables using a low-cost XO for LTE half-duplex MTC devices, thus making LTE a competitive

MTC system.

Exemplary embodiments of the present invention will now be de-scribed more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, server, corresponding component, and/or to any communication system or any combination of different communication systems that support machine type communication. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, an architecture based on LTE-A network elements, without restricting the embodiment to such an architecture, however. The embodiments described in these examples are not limited to the LTE-A radio systems but can also be implemented in other radio systems, such as LTE, LTE-M, UMTS (universal mobile telecommunications system), GSM, EDGE, WCDMA, bluetooth network, WLAN or other fixed, mobile or wireless network. In an embodiment, the presented solution may be applied between elements belonging to different but compatible systems such as LTE and UMTS.

A general architecture of a communication system is illustrated in FIG. 5. FIG. 5 is a simplified system architecture only showing some elements and functional entities, all being logical units whose implementation may differ from what is shown. The connections shown in FIG. 5 are logical connections; the actual physical connections may be different. It is apparent to a person skilled in the art that the systems also comprise other functions and structures. It should be appreciated that the functions, structures, elements and the protocols used in or for machine type communication, are irrelevant to the actual invention. Therefore, they need not to be discussed in more detail here.

The exemplary radio system of FIG. 5 comprises a network node 501 of a network operator. The network node 501 may include e.g. an LTE-M base station eNB of a cell, radio network controller (RNC), remote radio head (RRH), cloud server, or any other network element, or a combination of network elements. The network node 501 may be connected to one or more core network (CN) elements (not shown in FIG. 5) such as a mobile switching centre (MSC), MSC server (MSS), mobility management entity (MME), serving gateway (SGW), gateway GPRS support node (GGSN), serving GPRS support node (SGSN), home location register (HLR), home subscriber server (HSS), visitor location register (VLR). In FIG. 5, the radio network node 501 that may also be called eNB (enhanced node-B, evolved node-B) or network apparatus of the radio system, hosts the functions for radio resource management in the second cell of a public land mobile network.

FIG. 5 shows a user equipment 502 located in the service area of the radio network node 501. The user equipment refers to a portable computing device, and it may also be referred to as a user terminal. Such computing devices include wireless mobile communication devices operating with or without a subscriber identification module (SIM) in hardware or in soft-ware, including, but not limited to, the following types of devices: mobile phone, smart-phone, personal digital assistant (PDA), handset, laptop computer. In the example situation of FIG. 5, the user equipment 502 is capable of connecting to the radio network node 501 via a (cellular radio) connection 503, respectively.

FIG. 6 is a block diagram of an apparatus according to an embodiment of the invention. FIG. 5 shows a user equipment 502 located in the area of a radio network node 501. The user equipment 502 is configured to be in connection 503 with the radio network node 501. The user equipment or UE 502 comprises a controller 601 operationally connected to a memory 602 and a transceiver 603. The controller 601 controls the operation of the user equipment 502. The memory 602 is configured to store software and data. The transceiver 603 is configured to set up and maintain a wireless connection 503 to the radio network node 501, respectively. The transceiver 603 is operationally connected to a set of antenna ports 604 connected to an antenna arrangement 605. The antenna arrangement 605 may comprise a set of antennas. The number of antennas may be one to four, for example. The number of antennas is not limited to any particular number. The user equipment 502 may also comprise various other components, such as a user interface, camera, and media player. They are not displayed in the figure due to simplicity.

The radio network node 501, such as an LTE-M base station (eNode-B, eNB) comprises a controller 606 operationally connected to a memory 607, and a transceiver 608. The controller 606 controls the operation of the radio network node 501. The memory 607 is configured to store software and data. The transceiver 608 is configured to set up and maintain a wireless connection to the user equipment 502 within the service area of the radio network node 501. The transceiver 608 is operationally connected to an antenna arrangement 609. The antenna arrangement 609 may comprise a set of antennas. The number of antennas may be two to four, for example. The number of antennas is not limited to any particular number. The radio network node 501 may be operationally connected (directly or indirectly) to another network element of the communication system, such as a further radio network node, radio network controller (RNC), a mobility management entity (MME), a serving gateway (SGW), an MSC server (MSS), a mobile switching centre (MSC), a radio resource management (RRM) node, a gateway GPRS support node, an operations, administrations and maintenance (OAM) node, a home location register (HLR), a visitor location register (VLR), a serving GPRS support node, a gateway, and/or a server, via an interface (not shown in FIG. 6). The embodiments are not, however, restricted to the network given above as an example, but a person skilled in the art may apply the solution to other communication networks provided with the necessary properties. For example, the connections between different network elements may be realized with internet protocol (IP) connections.

Although the apparatus 501, 502 has been depicted as one entity, different modules and memory may be implemented in one or more physical or logical entities. The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminals include a personal computer, a game console, a laptop (a notebook), a personal digital assistant, a mobile station (mobile phone), a smart phone, and a line telephone.

The apparatus 501, 502 may generally include a processor, controller, control unit or the like connected to a memory and to various inter-faces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment.

The memory 602, 607 may include volatile and/or non-volatile memory and typically stores content, data, or the like. For example, the memory 602, 607 may store computer program code such as software applications or operating systems, information, data, content, or the like for a processor to perform steps associated with operation of the apparatus in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

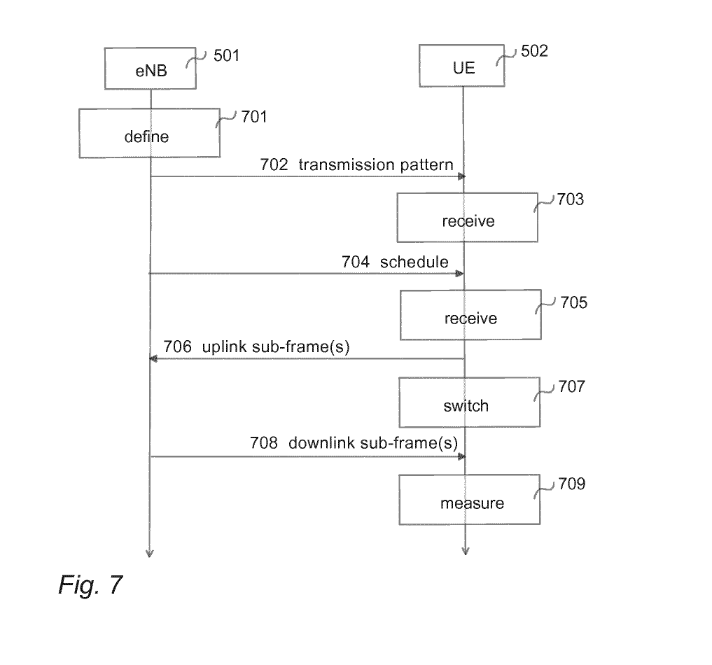

The signalling chart of FIG. 7 illustrates the required signalling. In the example of FIG. 7, an apparatus 501, which may comprise e.g. a network element (network node (scheduling node), e.g. a LTE-M-capable base station (enhanced node-B, eNB)) may, in item 701, define a transmission pattern for the user terminal. The user terminal may be a HD-FDD user terminal utilizing a coverage extension and/or coverage enhancement mode. The defined transmission pattern indicates sub-frames during which the user terminal is to perform uplink transmission, sub-frames during which the user terminal is to expect to perform downlink reception including reference symbols for performing downlink tracking, and at least one of 1) Tx-to-Rx switching sub-frame during which the user terminal is to switch from the uplink transmission to the downlink reception, and 2) Rx-to-Tx switching sub-frame during which the user terminal is to switch from the downlink reception to the uplink transmission. In item 702 the transmission pattern is provided to the user terminal. In item 703 the user terminal receives the transmission pattern. In item 704, the base station transmits scheduling information to the user terminal. In item 705 the user terminal receives the scheduling information. Based on the scheduling information the user terminal may transmit 706 one or more uplink sub-frames to the base station according to the transmission pattern. In item 707, during a Tx-to-Rx switching sub-frame, the user terminal may switch from the uplink transmission to the downlink reception according to the transmission pattern. In item 708 the base station may transmit one or more downlink sub-frames including reference symbols for performing downlink tracking in the user terminal. In item 709, the user terminal may receive the downlink sub-frames according to the transmission pattern, and perform downlink measurement based on the received one or more downlink sub-frames in order to maintain the frequency stability of the user terminal.

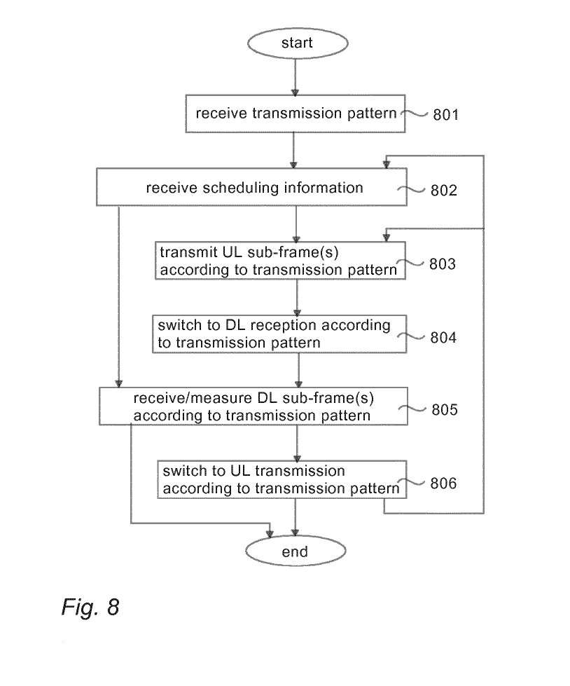

FIG. 8 is a flow chart illustrating an exemplary embodiment. The apparatus 502, which may comprise e.g. a communication node (user terminal, UE) may, in item 801, receive a transmission pattern defined for the user terminal. The user terminal may be a HD-FDD user terminal utilizing a coverage extension and/or coverage enhancement mode. The transmission pattern indicates sub-frames during which the user terminal is to perform uplink transmission, sub-frames during which the user terminal is to expect to perform downlink reception including reference symbols for performing downlink tracking, and at least one of 1) Tx-to-Rx switching sub-frame during which the user terminal is to switch from the uplink transmission to the downlink reception, and 2) Rx-to-Tx switching sub-frame during which the user terminal is to switch from the downlink reception to the uplink transmission. In item 802, the user terminal receives scheduling information from a base station. Based on the scheduling information the user terminal may transmit 803 one or more uplink sub-frames to the base station according to the transmission pattern (alternatively the process may continue from item 805 if so indicated by the transmission pattern). In item 804, during a Tx-to-Rx switching sub-frame, the user terminal may switch from the uplink transmission to the downlink reception according to the transmission pattern. In item 805, the user terminal may receive downlink sub-frames from the base station according to the transmission pattern, the one or more downlink sub-frames including reference symbols for performing downlink tracking in the user terminal, and perform downlink measurement based on the received one or more downlink sub-frames in order to maintain the frequency stability of the user terminal. The user terminal may, in item 806, during a Rx-to-Tx switching sub-frame, switch from the downlink transmission to the uplink reception according to the transmission pattern.

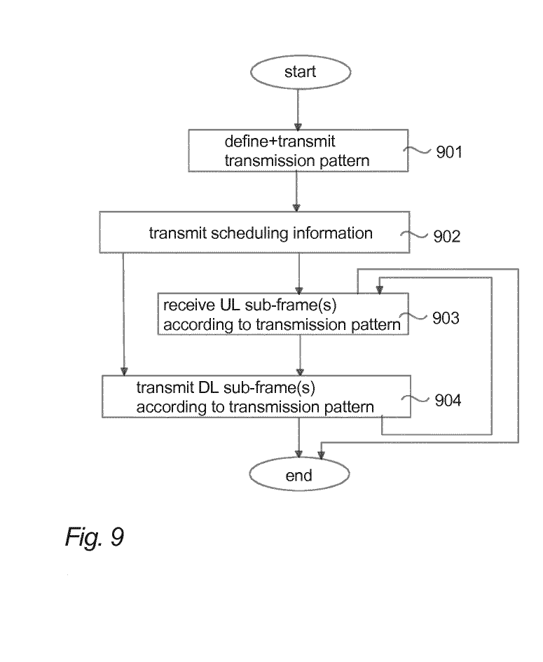

FIG. 9 is a flow chart illustrating an exemplary embodiment. The apparatus 501, which may comprise e.g. a network element (network node (scheduling node), e.g. a LTE-M-capable base station (enhanced node-B, eNB)), may, in item 901, define a transmission pattern for the user terminal. The user terminal may be a HD-FDD user terminal utilizing a coverage extension and/or coverage enhancement mode. The defined transmission pattern indicates sub-frames during which the user terminal is to perform uplink transmission, sub-frames during which the user terminal is to expect to perform downlink reception including reference symbols for performing downlink tracking, and at least one of 1) Tx-to-Rx switching sub-frame during which the user terminal is to switch from the uplink transmission to the downlink reception, and 2) Rx-to-Tx switching sub-frame during which the user terminal is to switch from the downlink reception to the uplink transmission. Further, in item 901, the transmission pattern is provided to the user terminal. In item 902, the base station transmits scheduling information to the user terminal. In item 903, the base station may receive one or more uplink sub-frames from the user terminal according to the transmission pattern defined for that user terminal (alternatively the process may continue from item 903 if so indicated by the transmission pattern). In item 904, the base station may transmit one or more downlink sub-frames including reference symbols for performing downlink tracking in the user terminal.

FIG. 9 shows a simplified flow chart, depicting eNB behavior with respect to one UE. However, an exemplary embodiment is also applicable to a situation where eNB is simultaneously supporting multiple UEs. When eNB is simultaneously supporting multiple UEs, eNB may be receiving uplink transmission from one user terminal while at the same time be performing downlink transmission to be received by another user terminal. Thus, when eNB is simultaneously supporting multiple UEs, there is no break-up of actions into sequential transmission/reception operations from the eNB's perspective (i.e. eNB utilizes FDD, not HD-FDD).

The base station may define and transmit a new transmission pattern to the user terminal, i.e. the transmission pattern may be updated, wherein the user terminal is configured to operate according to the updated transmission pattern (not shown in the figures).

The steps/points, signalling messages and related functions de-scribed above in FIGS. 1 to 9 are in no absolute chronological order, and some of the steps/points may be performed simultaneously or in an order differing from the given one. Other functions can also be executed between the steps/points or within the steps/points and other signalling messages sent between the illustrated messages. Some of the steps/points or part of the steps/points can also be left out or replaced by a corresponding step/point or part of the step/point. The apparatus operations illustrate a procedure that may be implemented in one or more physical or logical entities. The signalling messages are only exemplary and may even comprise several separate messages for transmitting the same information. In addition, the messages may also contain other information.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

MTC machine type communications

LTE-M long term evolution for MTC

XO crystal oscillator

TCXO temperature compensated crystal oscillator

LTE long term evolution

FCB frequency correction burst

SCB synchronization burst

DTX discontinuous transmission

HD-FDD half-duplex frequency division duplex

PDCCH physical downlink control channel

DL downlink

UL uplink

PSS primary synchronization signal

SSS secondary synchronization signal

DwPTS downlink pilot time slot

UE user terminal

eNB enhanced node-B

TTI transmission time interval

1. A method for transmission control of a user terminal utilizing a half-duplex frequency division duplex operation mode, the method comprising
receiving a transmission gap pattern in the user terminal,
the transmission qap pattern indicating
sub-frames during which the user terminal is to perform uplink transmission,
sub-frames during which the user terminal is to periodically interrupt the uplink transmission and to expect to perform downlink reception including at least reference symbols for performing downlink tracking, and
at least one of
a Tx-to-Rx switching sub-frame during which the user terminal is to switch from the uplink transmission to the downlink reception, and
a Rx-to-Tx switching sub-frame during which the user terminal is to switch from the downlink reception to the uplink transmission; and
operating the user terminal according to the transmission qap pattern.

2. A method for transmission control of a user terminal utilizing half-duplex frequency division duplex operation, the method comprising
defining a transmission gap pattern for at least one user terminal, the transmission gap pattern indicating
sub-frames during which the user terminal is to perform uplink transmission,
sub-frames during which the user terminal is to periodically interrupt the uplink transmission and to expect to perform downlink reception including at least reference symbols for performing downlink tracking, and
at least one of
a Tx-to-Rx switching sub-frame during which the user terminal is to switch from the uplink transmission to the downlink reception, and
a Rx-to-Tx switching sub-frame during which the user terminal is to switch from the downlink reception to the uplink transmission; and
providing the transmission qap pattern to the user terminal.

3. A method according to claim 1, wherein the method comprises transmitting, from the user terminal, one or more uplink sub-frames according to the transmission qap pattern; and receiving from a base station according to the transmission gap pattern one or more downlink sub-frames including at least the reference symbols for performing the downlink tracking.

4. (canceled)

5. A method according to claim 3, wherein the method comprises performing downlink measurement based on the received one or more downlink sub-frames in order to maintain the frequency stability of the user terminal.

6. (canceled)

7. A method according to claim 2, wherein the method comprises transmitting, to the user terminal, according to the transmission qap pattern one or more downlink sub-frames including at least the reference symbols for performing the downlink tracking and wherein a crystal oscillator is used in the user terminal for keeping timing and frequency reference.

8. A method according to claim 1, wherein if two crystal oscillators are used in the user terminal for keeping timing and frequency reference, the transmission qap pattern only indicates a single switching sub-frame including both Rx-to-Tx and Tx-to-Rx switching times, wherein the Tx-to-Rx switching is to be performed by using a timing advance.

9. A method according to claim 1, wherein the transmission qap pattern is defined for a user terminal utilizing at least one of a coverage extension mode and coverage enhancement mode and wherein the switching sub-frame includes information, such as downlink pilot time slot DwPTS information.

10. A method according to claim 1, wherein in case of a new carrier type NCT system, the downlink sub-frame is lined up with a primary synchronization signal PSS and a secondary synchronization signal SSS in the transmission gap pattern.

11. (canceled)

12. A method according to claim 1, wherein the transmission gap pattern is an orthogonal transmission pattern.

13. A method according to claim 1, wherein the method comprises configuring different user terminals with transmission gap patterns including non-concurrent uplink sub-frames.

14. A method according to claim 1, wherein the transmission gap pattern is provided to the user terminal as part of a connection set-up procedure.

15. A method according to claim 1, wherein the transmission gap pattern is based on at least one of a user terminal capability, required coverage extension, base station receiver performance, and uplink/downlink traffic distribution.

16. (canceled)

17. A method according to claim 1, wherein he method comprises updating the transmission gap pattern of the user terminal and the user terminal is scheduled to perform uplink transmissions in multiple sub-frames with a single scheduling assignment or a semi-persistent scheduling assignment.

18. A method according to claim 2, wherein the method comprises transmitting, to the user terminal, information for early termination of the uplink transmission during downlink sub-frames transmitted to the user terminal.

19. An apparatus comprising at least one processor, and at least one memory including a computer program code, wherein the at least one memory and the computer program code are configured to, with the at least one processor, cause the apparatus to perform any of the method steps of claim 1.

20. A computer program product comprising executable code that when executed, causes execution of functions of a method according to claim 1.

21. A method for transmission control of a user terminal utilizing a half-duplex frequency division duplex operation mode, the method comprising:
defining a periodic uplink transmission gap pattern comprising a plurality of sub-frames;
periodically interrupting a contiguous uplink period of the half-duplex frequency division duplex operation mode comprising a plurality of sub-frames in accordance with the transmission gap pattern; and
using the transmission gap substantially for downlink tracking based on reception of a downlink pilot.

22. A method according to claim 21, wherein a transmission gap in accordance with the transmission gap pattern consists of a sub-frame for Tx-to-Rx switching, a sub-frame for Rx-to-Tx switching and further sub-frames for the downlink tracking.

23. A method according to claim 21, wherein defining the periodic uplink transmission gap pattern comprises receiving an indication of the periodic uplink transmission gap pattern from a base station.

24. A method according to claim 21, wherein the interrupting during the periodic uplink transmission gap is performed at least in dependence of an uplink scheduling assignment.
